(19) United States
(12) Patent Application Publication
(10) Pub. No.: US 2002/0124630 A1
(43) Pub. Date: Sep. 12, 2002

(54) Process for determining the gas composition of the fuel gas

(76) Inventors: Manfred Jaeschke, Dorsten (DE); Peter Schley, Essen (DE); Renee Janssen- van Rosmaien, WE Roden (NL); Jan A. Schouten, GT Monnickendam (NL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/039,522

(22) Filed: Jan. 4, 2002

Related U.S. Application Data
(63) Continuation-in-part of application No. 09/259,920, filed on Mar. 1, 1999, now abandoned.

(30) Foreign Application Priority Data
Feb. 28, 1998 (DE) 198 08 533.8

(51) Int. Cl. G01N 25/00

(52) U.S. Cl. 73/23.2; 422/83

(57) ABSTRACT

The gross calorific value of the fuel gas and its density under normal conditions are recorded. Furthermore, the carbon dioxide content of the fuel gas is measured. The gas composition can be reliably determined from these three parameters without the use of a gas chromatograph.

### FIELD OF THE INVENTION

The present invention relates to a process for determining the gas composition of fuel gas, in particular natural gas.

### BACKGROUND OF THE INVENTION

It is known that gas compositions can be measured using a gas chromatograph. Gas chromatographs provide exact measurements of the gas composition but are extremely expensive to buy and maintain.

### THE INVENTION

It is an object of the present invention to provide a lower-cost method of determining the gas composition of fuel gas.

This object is achieved by the inventive process mentioned hereinabove wherein

a) the gross calorific value or the dielectric constant of the fuel gas under reference or operating conditions and the density or acoustic velocity of the fuel gas under reference or operating conditions are recorded and

b) the gas composition is derived from the two measurement signals recorded.

The gross calorific value can, for example, be determined with the aid of calorimetric procedures in which controlled combustion of a side stream of the gas flow is performed. Alternatively, the gross calorific value can be determined with the aid of known non-combustion correlative procedures. Various time-tested procedures exist in practice for measuring the dielectric constant, density as well as acoustic velocity. These procedures can be performed reliably and accurately without any particularly complicated apparatus. The combination of the measured values provides the results to determine the gas composition.

The gas composition determined in this manner correlates to more than 0.1% with the percentages of the main components of natural gas, i.e. methane, ethane and nitrogen, determined with the aid of a gas chromatograph.

At points where the necessary measurement signals have already been recorded for billing purposes, additional measurement of the gas composition is no longer necessary. The gas composition can be measured with a gas chromatograph as a check at given intervals, e.g. once a year. Particularly exact results can be achieved for fuel gases whose gross calorific value under normal conditions is between 20 and 48 MJ/m_, whose relative density related to dry air is between 0.55 and 0.9, whose carbon dioxide content is less than or equal to 0.3 and whose hydrogen and carbon monoxide contents are less than 0.1 and 0.03, respectively. Temperatures ranging between 225 and 350 K and pressures of less than or equal to 60 MPa are particularly suitable measuring conditions.

The accuracy of gas composition measurement can be further increased by additionally recording at least one of the measurands pressure, temperature, carbon dioxide content, carbon monoxide and hydrogen contents of the fuel gas in step a). Naturally, the highest measuring accuracy is achieved when all additional measurands are recorded.

To establish a suitable correlation between the measurement signals recorded and the gas composition, it is advantageous to perform several measurement cycles at least once prior to steps a) and b), where step a) is performed with several reference gases of known composition. The measurands necessary for the different variants of the processes are then determined for each reference gas. In these reference cycles, a number of reference signal patterns corresponding to the number of measurement cycles and based on the ratio of the measurement signals recorded are stored and assigned to the known compositions. The signal pattern from a subsequent measurement cycle on fuel gas of unknown composition is compared with these reference signal patterns to assign the fuel gas to a certain composition.

In order to increase the reference accuracy, a large number of reference cycles should be performed in which the contents of the individual components are varied, if possible one after the other, based on the contents of the components to be expected in the fuel gas. A clear and exact assignment of a certain gas composition to a signal pattern of a fuel gas recorded in a measurement cycle is achieved by interpolation of the various reference signal patterns. The composition of the reference gases should be selected to be as close as possible to the gas compositions to be subsequently measured.

A preferred embodiment of the present invention is characterised in that the respective content of a given number of alkanes, including methane, is determined in that the contents of the individual alkanes, with the exception of methane, are each determined with the aid of a relevant function dependent on a selected physical measurand, preferably the molar gross calorific value, of the sum of the given alkanes and that the methane content is determined from the difference between the sum of the contents of the given alkanes and the sum of the contents of the alkanes determined by the functions.

All the alkanes actually present in the fuel gas should, if possible, be selected as the given alkanes.

It has been shown that the contents of the alkanes in natural fuel gases are always in a certain ratio to each other which only depends on a physical measurand, e.g. the molar gross calorific value, of the sum of the given alkanes. This is obviously a result of the fact that natural gases in their natural form have always undergone a phase of equilibrium in which their gas or liquid phases were in equilibrium. However, this process is not restricted to the natural fuel gases with or without coking gas additives. For synthetic gases with additives or for gas mixtures with many components, the uncertainty in the determination of the gas composition is only slightly greater.

The molar gross calorific value of the sum of the given alkanes can for example be determined with the aid of reference signal cycles. As the composition of reference gases is known, their molar gross calorific value of the sum of the given alkanes is also known. Consequently, a number of reference signal patterns corresponding to the number of reference measurement cycles and based on the ratio of the measurement signals recorded with the reference gases are stored and assigned to the known molar gross calorific values of the sum of the given alkanes. In a subsequent measurement cycle, the molar gross calorific value of the sum of the given alkanes of the fuel gas can be determined simply by comparing the measurement signals recorded with the reference signal patterns stored.

The selected physical measurand of the sum of the given alkanes can be selected at will depending on the application in question. For example, instead of the molar gross calorific value, it is possible to use the molar mass, the density or the acoustic velocity.

It is advantageous to use polynomials, preferably of the second order, as functions to determine the contents of the individual alkanes, with the exception of methane.

The following relations are used to calculate/determine the gas composition of the fuel/natural gas from the measured input parameters. The input parameter used to characterize the gas composition are e.g. the density at reference conditions pₙ, the mole fraction of CO₂ and the gross calorific value H_{S}. From the input data the mole fractions of nitrogen and of the sum of the hydrocarbon components (alkanes) are determined.

In a preferred embodiment of the present invention, the contents of methane, ethane, propane, isobutane, n-butane, isopentane, n-pentane, hexane, heptane and octane are determined with the aid of the functions. It has been shown that the contents of all other alkanes can be disregarded, particularly with natural fuel gas. The relation to the molar gross calorific value of the sum of the given alkanes is in this case for example:

X_{C}_{₂}_{H}_{₆}=[α₁(H_{CH}−H_{CH}_{₄})+β₁(H_{CH}−H_{CH}_{₄})²]x_{CH} (1.1)

X_{C}_{₃}_{H}_{₈}=[α₂(H_{CH}−H_{CH}_{₄})+β₂(H_{CH}−H_{CH}_{₄})²]x_{CH} (1.2)

X_{i-C}_{₄}_{H}_{₁₀}=[α₃(H_{CH}−H_{CH}_{₄})+β₃(H_{CH}−H_{CH}_{₄})²]x_{CH} (1.3)

X_{n-C}_{₄}_{H}_{₁₀}=[α₄(H_{CH}−H_{CH}_{₄})+β₄(H_{CH}−H_{CH}_{₄})²]x_{CH} (1.4)

X_{i-C}_{₅}_{H}_{₁₂}=[α₅(H_{CH}−H_{CH}_{₄})+β₅(H_{CH}−H_{CH}_{₄})²]x_{CH} (1.5)

X_{n-C}_{₂}_{H}_{₆}=[α₆(H_{CH}−H_{CH}_{₄})+β₆(H_{CH}−H_{CH}_{₄})²]x_{CH} (1.6)

X_{n-C}_{₆}_{H}_{₁₄}=[α₇(H_{CH}−H_{CH}_{₄})+β₇(H_{CH}−H_{CH}_{₄})²]x_{CH} (1.7)

X_{n-C}_{₇}_{H}_{₁₆}=[α₈(H_{CH}−H_{CH}_{₄})+β₈(H_{CH}−H_{CH}_{₄})²]x_{CH} (1.8)

X_{n-C}_{₈}_{H}_{₁₈}=[α₉(H_{CH}−H_{CH}_{₄})+β₉(H_{CH}−H_{CH}_{₄})²]x_{CH} (1.9)

Here αᵢ and βᵢ are constants and H_{CH}_{₄} the molar gross calorific value of methane. The variable H_{CH} stands for the molar calorific value of the sum of the given alkanes

(H_{CH}=ΣX_{CH}, iH_{CHi})/X_{CH}). In this equation XCH is the mole fraction of the sum of the given alkanes (X_{CH}=X_{CH}, i). The methane content is determined in this case as follows:

X_{CH}_{₄}=X_{CH}−(X_{C}_{₂}_{H}_{₆}+H_{C}_{₃}_{H}_{₈}+X_{i-C}_{₄}_{H}_{₁₀}+X_{n-C}_{₄}_{H}₁₀+X_{i-C}_{₅}_{H}_{₁₂}+X_{n-C}_{₅}_{H}₁₂+X_{n-C}_{₆}_{H}_{₁₄}+X_{n-C}_{₇}_{H}_{₁₆}+X_{n-C}_{₈}_{H}_{₁₈}) (2)

A further embodiment of the present invention is characterised in that several measurement cycles are performed prior to steps a) and b), in which measurement cycles step a) is performed with several reference gases, whose composition and whose selected physical measurand of the sum of the given alkanes is known, that the constants, for example coefficients, of the functions describing the content of the alkanes, with the exception of methane, are determined from the measurement signals recorded with the reference gases, that the constants of the functions are stored and assigned to the relevant alkanes and that the content of the alkanes, with the exception of methane, is determined from a subsequent measurement cycle on a fuel gas of unknown composition with the aid of the functions (see e.g. FIG. 1).

In this manner the constants αᵢ and αᵢ can be found for all natural gases with the aid of only two reference cycles. To increase the measuring accuracy, as many reference cycles as desired can be performed. Even with a large number of reference cycles, the time required is relatively short as the constants αᵢ and αᵢ only have to be determined once.

The molar gross calorific value of the sum of the given alkanes is advantageously determined as a linear function of the molar mass of the sum of the given alkanes. The appropriate equation for natural gases is:

M_{CH}=b₀+b₁H_{CH} (3)

where MCH is the molar mass of the sum of the given alkanes. b₀ and b₁ are constants and are −2.68454 and 0. 0210273.

The nitrogen content and the molar mass of the sum of the given alkanes can be determined from the molar mass of the fuel gas assuming that the fuel gas only consists of a given number of alkanes, nitrogen and carbon dioxide. The relevant equations are therefore as follows:

X_{N}_{₂}=1−X_{CH}−X_{CO}_{₂} (4)

where X_{N}_{₂} and X_{CO}_{₂} indicate the nitrogen content and carbon dioxide content, respectively. Thus for the molar mass of the fuel gas (Mₘᵢₓ) it follows:

Mₘᵢₓ=X_{CH}M_{CH}+X_{N}_{₂}M_{N}_{₂}+X_{CO}_{₂}M_{CO}_{₂} (5)

In order to increase the measuring accuracy, it can alternatively be assumed that the fuel gas also contains hydrogen and/or carbon monoxide. If both the hydrogen content and carbon monoxide content are also taken into consideration, the equations (4) and (5) are as follows:

X_{N}_{₂}=1−X_{CH}−X_{CO}_{₂}−X_{H}_{₂}−X_{CO} (4′)

Mₘᵢₓ=X_{CH}M_{CH}+X_{N}_{₂}M_{N}_{₂}+X_{CO}_{₂}M_{CO}_{₂}+X_{H}_{₂}M_{H}_{₂}+X_{CO}M_{CO} (5′)

The molar gross calorific value of the sum of the given alkanes is preferably derived from the density recorded, the gross calorific value recorded, the molar mass of the fuel gas, the sum of the contents of the given alkanes and, optionally, from the content as well as the molar gross calorific value of hydrogen and carbon monoxide. The relevant equation is as follows:

H_{S}=ρₙ(X_{CH}H_{CH}+X_{H}_{₂}H_{H}_{₂}+X_{CO}H_{CO})Mₘᵢₓ (6)

where H_{S} is the gross calorific value recorded and ρₙ the density recorded under normal conditions.

The equations (3) through (6) can be combined so that the molar gross calorific value H_{CH} of the sum of the alkanes can be calculated from the input values and the already estimated (determined) values for the mole fractions of the nitrogen X_{N2} and the sum of the alkanes X_{CH}.

H_{CH}=(bₒ+(X_{N2}M_{N2}+X_{CO2}M_{CO2})·X_{CH}⁻¹)·(ρₙH_{S}⁻¹−b₁)⁻¹ (7)

(See FIG. 2, Step 4)

According to a preferred embodiment the density under normal conditions is determined therefrom as follows:

$${ρ}_{n} = \frac{{p}_{n} {M}_{mix}}{{Z}_{n} {R}_{m} {T}_{n}} \qquad ( 8 )$$

wherein

Tₙ is the temperature in a reference condition (i.e. normal conditions: 273.15K);

pₙ is the pressure in a reference condition (e.g. normal conditions: 101.325kPa); and

Rₘ is the universal gas constant (Rₘ=8.31451 Jmol⁻¹K⁻¹)

A further embodiment of the present invention is characterised in that a value for the density of the fuel gas is derived from the composition of the fuel gas, that the difference between the derived and the recorded value for the density is established, that, if the difference exceeds a given threshold value, the content of at least one of the components of the fuel gas to be determined is changed, that, on the basis of the changed value, the composition, the density and the difference are again determined, and that the last two steps are repeated until the difference is below the threshold value.

It has been shown that this way is a particularly quick method of determining the gas composition. If all 16 equations (1.1-8) given hereinabove are taken into consideration, they contain up to 16 unknown factors, namely X_{CH}_{₄}, X_{N}_{₂}, X_{C}_{₂}_{H}_{₆}, X_{C}_{₃}_{H}_{₃}, . . . X_{n-C}_{₈}_{H}_{₁₈}, Mₘᵢₓ, X_{CH}, H_{CH}, M_{CH}, Zₙ. To solve these 16 equations, a value, e.g. the density, can be derived and compared with the relevant value recorded (see flow chart in FIG. 2).

The molar mass of the fuel gas Mₘᵢₓ and the real gas factor Zₙ Zₙ=f(Tₙ,pₙ,Xᵢ) can be calculated from the derived gas composition with DIN 51857 or ISO 6976.

The process according to the present invention can be used for determining the real gas factor, the density, the acoustic velocity, the enthalpy, the methane number or the Wobbe index of the fuel gas. The physical values determined in accordance with the inventive process are of substantially the same quality as those determined with the aid of a gas chromatograph. According to the present invention, a large number of calculations can be performed solely with the aid of two measurands, e.g. the gross calorific value and the density under normal conditions. First of all, changes in the state of the gas in gas storage vessels or changes in storage volume can be established. Furthermore, the relevant gas transmission data, e.g. temperature or fall in pressure, can also be determined. The necessary design of the gas filling stations can also be calculated for natural gas vehicles. Filling levels can be checked and interpreted with the inventive process.

The present invention is also of great advantage in connection with heat exchangers. The design of heat exchangers can be calculated with the inventive process. Measurements of heat exchanger performance can be evaluated with this process. Finally, compressor envelopes and compressor ratings can be determined with the inventive process.

With all the above-mentioned applications, costly gas chromatographic tests were previously necessary.

The methane number can also be determined with the process according to the present invention. If the gas composition data which were originally measured for billing purposes are used as the input measurement signals for the process according to the present invention, the methane number can be substantially determined with the same accuracy as with a gas chromatograph. The deviation in the methane numbers is less than 2%.

Alternatively, the gas composition data, e.g. gross calorific value and density under normal conditions, can be determined from a net simulation. Net simulations can currently determine the gross calorific value with an uncertainty of less than 1% and the density under normal conditions with an uncertainty of 1.5%. The carbon dioxide content can, in this case, be simply set as the average value of 1 mol %. The methane number determined in this manner in accordance with the inventive process generally shows an even better correlation than 2% with the methane number determined using a gas chromatograph. This accuracy is sufficient for most fields of application.

With applications in which a volumeter or mass flow meter is available, it is advantageous to take the measurement signal for the acoustic velocity at this volumeter or mass flow meter.

When gas composition data measured for billing purposes or net simulations are used, it is possible, without any additional measurements, for fuel gas consumers to obtain information at any time on the current and, in some cases, future variations in the methane number. The gas transmission network can, moreover, be controlled more flexibly without any additional cost.

Further advantageous embodiments of the present invention are characterised in the sub-claims.

In the following, the invention will be explained in more detail using a preferred embodiment and the attached drawings.

### BRIEF DESCRIPTION OF THE DRAWINGS

FIG. 1 is a graph in which the molar fraction of ethane and propane for different gases is plotted against the molar gross calorific value of the sum of the hydrocarbons.

FIG. 2 is a flow chart to determine the gas composition in accordance with an embodiment of the inventive process.

### DETAILED DESCRIPTION

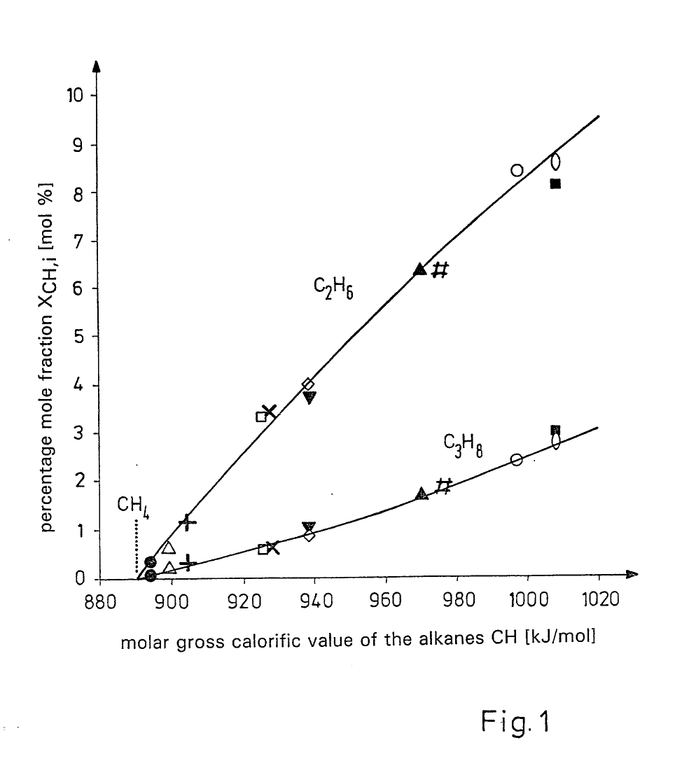

In FIG. 1 the molar gross calorific value of the sum of the alkanes (H_{CH}) is plotted on the x-axis and the molar fraction of ethane (C₂H6) and propane (C₃H₈) on the y-axis. The corresponding measurements are determined and entered for the various natural gases. The content of both ethane and propane is approximated by a polynominal of the second order. As FIG. 1 shows, both the content of ethane and that of propane can be approximated surprisingly well by a polynominal of the second order, which depends on the molar gross calorific value of the sum of the alkanes. The same applies to other alkanes up to octane. The measurements for these alkanes are not shown in FIG. 1 to keep the graph easy to understand.

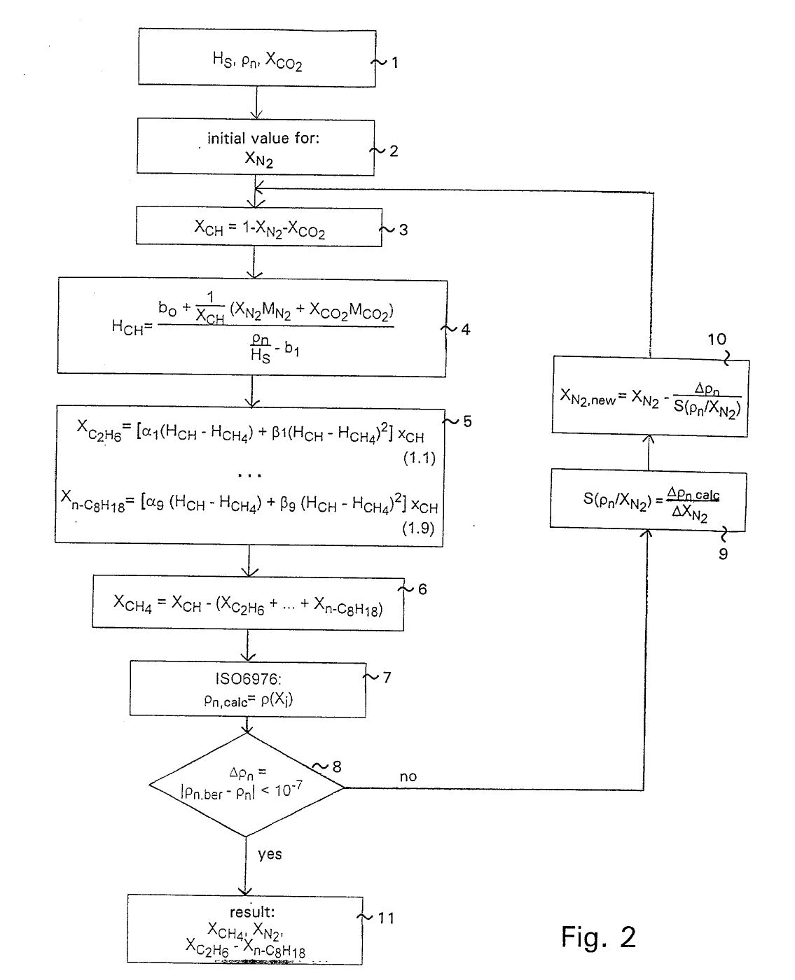

FIG. 2 shows a flow chart to determine the gas composition in accordance with a preferred embodiment. The gross calorific value of the fuel gas H_{S}, the density under normal conditions ρₙ as well as the carbon dioxide content X_{CO}_{₂} are measured in step 1. A starting value for the content of nitrogen X_{N}_{₂} is fixed in step 2. Then in step 3 the content of the sum of alkanes X_{CH} is determined from the carbon dioxide content recorded and the starting value for the nitrogen content. With the aid of the calculated value of the content of the sum of the alkanes X_{CH}, the molar gross calorific value of the sum of the alkanes X_{CH} can then be determined in step 4. The equation (7) used can be derived from the equations (2) through (6). Here, it must be remembered that in this embodiment the carbon monoxide and hydrogen contents are negligible and can therefore be taken as zero.

In step 5, the content of alkanes, with the exception of methane, is calculated with the aid of the determined molar gross calorific value of the sum of the alkanes H_{CH} using the equations (1.1) though (1.9). In step 6, the methane content X_{CH}_{₄} is determined in accordance with equation (2). In step 7, the density under normal conditions ρₙ, _{calc.} is calculated from the calculated composition of the gas from equation (8). This is achieved with the aid of the known ISO 6976, i.e. through the real gas factor in accordance with the equation (8) and the molar mass of the fuel gas. Step 8 establishes whether the difference between the calculated normal density ρₙ, _{calc.} and the normal density recorded in step 1 is smaller than the threshold value set to 10⁻⁷. If not, the process is continued with step 9.

The sensitivity S (ρₙ/X_{N}_{₂}) is determined in step 9. For this purpose, a ΔX_{N}_{₂} is established, e.g. 0.01%, and a second value for ρₙ, _{calc.} is determined for a correspondingly changed value of the nitrogen content using the steps 3 to 8. The difference between these two calculated values for the density, Δρₙ, _{calc.,} is then divided by ΔX_{N}_{₂}. In step 10, a new value for the nitrogen content X_{N}_{_{2new}} is then established by deducting the quotient of the Δρₙ and S (ρₙ/X_{N}_{₂}) determined in step 8 from the starting value of the nitrogen content. Steps 3 to 8 are then repeated with the newly established value for the the nitrogen content. If the threshold value of Δρₙ is exceeded again in step 8, steps 9, 10 and 3 to 8 are performed again. Only when the threshold value of 10⁻⁶ of Δρₙ is observed in step 8 are the alkane contents as well as the nitrogen content established with the desired accuracy.

The starting value for the nitrogen content can be determined in step 2, for example, by using the molar gross calorific value of methane (H_{CH}=H_{CH}_{₄}) as well as X_{CH} from step 3 of the flow chart in FIG. 2 for the mole fractions of the alkanes as the molar gross calorific value of the sum of the alkanes. If this gross calorific value of methane is entered in the equation given in step 4, a starting value for the nitrogen content is obtained after a suitable solution.

A large number of variations to this invention are possible within the scope of the invention. The measurands required to determine the gas composition can either be measured or preferably be taken from measurement simulations based on measurements. Instead of the absolute density, the relative density related to dry air can be recorded. The given alkanes to be determined can be selected at will for a particular field of application. Finally, the 16 equations given can be solved in any way and in any order.

1. A process for determining the gas composition of fuel gas, in particular natural gas, comprising the following steps
a) one of the values gross calorific value and dielectric constant of the fuel gas is recorded as a measurement signal under one of the conditions reference conditions and operating conditions and one of the values density and acoustic velocity of the fuel gas is recorded as a measurement signal under one of the conditions reference conditions and operating conditions and
b) the gas composition is derived from the two measurement signals recorded.

2. The process according to claim 1, wherein normal conditions are set as reference conditions for measuring at least one of the values gross calorific value, dielectric constant, density and acoustic velocity.

3. The process according to claim 1, wherein in addition at least one of the measurands pressure, temperature, carbon dioxide content, carbon monoxide and hydrogen contents of the fuel gas is recorded in step a).

4. The process according to claim 1, wherein several measurement cycles are performed prior to steps a) and b), where step a) is performed with several reference gases of known composition, a number of reference signal patterns corresponding to the number of measurement cycles and based on the ratio of the measurement signals recorded with the reference gases are stored and assigned to the known compositions, and the signal pattern from a subsequent measurement cycle on fuel gas of unknown composition is compared with the reference signal patterns to assign the fuel gas a certain composition.

5. The process according to claim 1, wherein the respective content of a given number of alkanes, including methane, is determined in that the contents of the individual alkanes, with the exception of methane, are each determined with the aid of a relevant function dependent on a selected physical measurand of the sum of the given alkanes, and the methane content is determined from the difference between the sum of the contents of the given alkanes and the sum of the contents of the given alkanes and the sum of the contents of alkanes determined by the functions.

6. The process according to claim 5, wherein the molar gross calorific value is the selected physical measureand of the sum of given alkanes.

7. The process according to claim 5, wherein a polynomine is used as the function.

8. The process according to claim 7, wherein the polynomine is of the second order.

9. The process according to claim 5, wherein the contents of methane, ethane, propane, isobutane, n-butane, isopentane, n-pentane, hexane, heptane and octane are determined with the aid of the functions.

10. The process according to claim 5, wherein several measurement cycles are performed prior to steps a) and b), in which measurement cycles step a) is performed with several reference gases, whose composition and whose selected physical measurand of the sum of the given alkanes is known,
the constants of the functions describing the content of the alkanes, with the exception of methane, are determined from the measurement signals recorded with the reference gases,
the constants of the functions are stored and assigned to the relevant alkanes and
the content of the alkanes, with the exception of methane, is determined from a subsequent measurement cycle on a fuel gas of unknown composition with the aid of the functions.

11. The process according to claim 10, wherein the coefficients are the constants of the functions describing the content of the alkanes, with the exception of methane.

12. The process according to claim 5, wherein the selected physical measurand of the sum of the given alkanes is determined as a linear function of another physical measurand of the sum of the given alkanes.

13. The process according to claim 12, wherein the molar gross calorific value is the selected physical measurand of the sum of given alkanes.

14. The process according to claim 12, wherein the molar mass is the other physical measurand of the sum of the given alkanes.

15. The process according to claim 5, wherein, assuming that the fuel gas only consists of a given number of alkanes, nitrogen and carbon dioxide, both the nitrogen content and, with the aid of the molar mass of the fuel gas, the molar mass of the sum of the given alkanes are determined.

16. The process according to claims 5, wherein, assuming the fuel gas only consists of a given number of alkanes, nitrogen, carbon dioxide and at least one of the components hydrogen and carbon monoxide, both the nitrogen content and, with the aid of the molar mass of the fuel gas, the molar mass of the sum of the given alkanes are determined.

17. The process according to claim 5, wherein the molar gross calorific value of the sum of the given alkanes is derived from the density recorded, the gross calorific value recorded, the molar mass of the fuel gas and the portion of the sum of the given alkanes.

18. The process according to claim 17, wherein the molar gross calorofic value of the sum of the given alkanes is derived additionally from the portion as well as the molar gross calorific value of hydrogen and carbon monoxide.

19. The process according to claim 1, wherein
the real gas factor is derived from the composition and
the molar mass of the fuel gas is derived from the density and the real gas factor.

20. Method according to claim 1, wherein
a value for the density of the fuel gas is derived from the composition of the fuel gas,
the difference between the derived and the recorded value for the density is established,
if the difference exceeds a given threshold value, the content of at least one of the components of the fuel gas to be determined is changed,
on the basis of the changed value, the composition, the density and the difference are again determined, and
the last two steps are repeated until the difference is below the threshold value.

21. The process according to claim 1, wherein the dieletric constant and one of the values density and acoustic velocity are recorded under reference conditions in a common measuring environment.

22. The process according to claim 1, wherein a reference pressure of at least 1 MPa is set as the reference condition for measuring the dielectric constant.

23. The process according to claim 1, wherein the measurement signal for the acoustic velocity is taken at one of the devices volumeter and mass flow meter.

24. Use of the process according to claim 1 to determine one of the values real gas factor, density, acoustic velocity, enthalpy, methane number and Wobbe index of the fuel gas.
